(19) United States
(12) Patent Application Publication
(10) Pub. No.: US 2025/0146844 A1
(43) Pub. Date: May 8, 2025

(54) CLAMPING MOUNT FOR A SENSOR

(71) Applicant: Balluff GmbH, Neuhausen a.d.F. (DE)

(72) Inventors: Matthias Hofmann, Nürtingen (DE); Holger Haupt, Denkendorf (DE)

(21) Appl. No.: 18/906,716

(22) Filed: Oct. 4, 2024

(30) Foreign Application Priority Data
Oct. 5, 2023 (DE) 10 2023127 086.9

(51) Int. Cl. G01D 11/30; F16B 2/06

(52) U.S. Cl. CPC G01D 11/30; F16B 2/065

(57) ABSTRACT

A clamping mount for a sensor (500) has a clamping sleeve and a clamping nut (200). The clamping sleeve has a first section, in which the clamping sleeve is divided by slots into fins (112) extending parallel to its longitudinal axis, and a second section with an external thread (121). The clamping nut (200) has a first section in which the clamping nut has an internal thread with which it is screwed onto the external thread (121) of the clamping sleeve in such a way that the fins (112) are bent inwards into an interior space of the clamping sleeve. In a second section of the clamping nut, its inner lateral surface is angled inwards by an internal angle of at least 5°.

### CROSS-REFERENCE TO RELATED APPLICATIONS

This application is based on and claims the benefit of priority from German Patent Application No.: DE 10 2023 127 086.9, filed on Oct. 5, 2023, the entirety of which is incorporated by reference herein.

### TECHNICAL FIELD

The present invention relates to a clamping mount for a sensor.

### PRIOR ART

Cylindrical sensors, in particular inductive distance sensors, can have an external thread and be fastened by means of two nuts in a hole in a housing wall. Since such sensors have small switching distances of just a few millimetres, they must be placed very precisely. After placing the sensor, it is fixed in the appropriate position in the housing wall by means of two nuts arranged on an external thread of the sensor housing. Following maintenance or replacement of the sensor, however, the latter has to be precisely placed once again.

Therefore, sensor mounts which can be fastened on a housing wall have been proposed. When replacing the sensor, the sensor mount remains in its position, so that the switching distance can be re-established immediately.

DE 10 2012 023 193 B4 discloses a sensor mount with a threaded sleeve which receives the sensor and has an axial fixed stop in the tube interior. Arranged on the threaded sleeve is a clamping device, by means of which a sensor to be positioned in the threaded sleeve can be clamped. The clamping device is a clamping sleeve positioned in a rotationally fixed manner in the threaded sleeve with at least one radial pressing piece which projects resiliently over the threaded sleeve and interacts with an internal taper of a nut arranged on the threaded sleeve in such a way that the rotation of the nut causes a radial movement of the at least one pressing piece directed into the interior of the clamping sleeve. The pressing piece has a curved and conical external face which is matched to the internal taper of the nut.

DE 196 41 137 C2 discloses a sensor mount with a retaining element in the form of a ring, a sleeve for receiving the sensor and a stop for the defined positioning of the latter in the area of an end face of the sleeve. The sleeve consists, with respect to its longitudinal axis, of a non-slotted area and a slotted area. The outside diameter of the non-slotted area is constant. The ring is able to move on the sleeve. The stop is located in the non-slotted area on the end face within the sleeve. The slotted area has at least one elongated slot in the axial direction and at least one annular insert that can be fixed in the sleeve to receive the sensor. Each insert has a stud extending in the axial direction in the area of the elongated slots of the sleeve. By displacing and/or by turning the retaining element in the slotted area of the sleeve, a force can act on the stud(s) and thus the stud(s) can be clamped to the sensor.

However, such clamping mounts for sensors consist of metal and can negatively influence the sensitivity of the sensor, since the latter is fixed in place in the clamping mount surrounded by metal. Moreover, a tool is needed in order to clamp a sensor with such a clamping mount. Nevertheless, such clamping mounts can cause unstable clamping. They also only have a small amount of clearance with respect to the outside diameter of a sensor that can be inserted into the clamping mount.

It is therefore the object of the present invention to provide a clamping mount for a sensor which can be manufactured from a non-metallic material and can be clamped in the sensor without the aid of a tool. In addition, the clamping mount should be able to be used for clamping circular-cylindrical sensors with different outside diameters.

### DISCLOSURE OF THE INVENTION

This problem is solved by a clamping mount for a sensor, in particular for a circular-cylindrical sensor. This sensor can be an inductive proximity sensor or proximity switch, for example. The clamping mount has a clamping sleeve and a clamping nut. The clamping sleeve has a first section, in which the clamping sleeve is divided by slots into fins extending parallel to its longitudinal axis. It has an external thread in a second section. If the clamping sleeve is compressed in its first section by pressure from the outside, the inside diameter of the clamping mount is reduced in its first section and the fins can clamp a sensor inserted into the clamping sleeve. Since the inside diameter of the clamping sleeve may be larger here than the outside diameter of the sensor, this clamping sleeve makes it possible to clamp differently dimensioned sensors. The principle of clamping a cylindrical body in a clamping sleeve in which fins of the clamping sleeve, which are separated from each other by slots parallel to the longitudinal axes, are pressed together is known, for example, from the field of hose connectors and is referred to there as the Gardena® principle. There, however, the cylindrical body is only contacted by the tips of the fins, resulting in unstable clamping. This would not suffice to position a sensor exactly. According to the invention, however, it has been found that by suitably designing the clamping nut, the contact area between the fins and the sensor can be enlarged. When pressed together, the fins are deformed in such a way that they touch the sensor not with their tips but with part of their interior surface, thereby reliably preventing the sensor from slipping along the longitudinal axis of the clamping sleeve. The clamping nut has an internal thread. It is screwed with the internal thread onto the external thread of the clamping mount in such a way that the fins are bent into an interior space of the clamping sleeve. To mount a sensor in the clamping mount, the former is inserted into the clamping sleeve, the clamping nut is guided over the sensor and then tightened on the external thread of the clamping mount. By unscrewing the clamping nut, the sensor can be removed from the clamping sleeve and therefore from the clamping mount again. In order to deliberately bend the fins of the clamping sleeve so that they bear against the sensor with a large contact area, the clamping nut has a first section with the internal thread and a second section in which the inner lateral surface of the clamping nut is angled inwards by an internal angle of at least 5°. This internal angle forces the fins into a curved shape dictated by the internal angle so that they are pressed against the sensor. It is not necessary here for the second section to bear directly against the first section. Rather, it is possible for a further section to be arranged between the two sections, for example, which does not have an internal thread but in which the inner lateral surface is not yet angled inwards. If the clamping sleeve has a section in which the clamping sleeve is neither slotted nor has an external thread, the section of the clamping nut, which has neither an internal thread nor an angled inner lateral surface, can receive that section of the clamping sleeve.

It is possible to take the sensor out of the clamping mount and reinsert it in the latter without having to remove the clamping nut completely from the clamping mount. Instead, it is sufficient to loosen the clamping nut for this purpose. As a result, it is possible to replace the sensor with very little effort.

A length of the first section of the clamping sleeve and therefore a length of the fins is preferably in the range from 5 mm to 15 mm and particularly preferably in the range from 6 mm to 12 mm. It has been shown that, on the one hand, this length of the fins enables a sufficiently large area of contact between the clamping sleeve and the sensor and, on the other hand, provides the first section of the clamping sleeve with sufficient stability.

The first section of the clamping sleeve preferably has 12 to 20 slots. Furthermore, it is preferred that the fins in the uncompressed state of the clamping sleeve each have a longitudinal axis that extends parallel to the longitudinal axis of the clamping sleeve.

The slots preferably each have an angle in the range from 10° to 50°, preferably in the range from 15° to 30°, with respect to a line parallel to the longitudinal axis. This makes the fins twist when the clamping nut is tightened. This results in better elastic behaviour of the bent fins, meaning that greater tolerances of the sensor can be offset.

In order to improve the clamping effect of the clamping sleeve with respect to the sensor even further, it is preferred that at least 3 fins each have a projection which projects into an interior space of the clamping sleeve and has a triangular cross-section. Particularly preferably, at least ⅓ of the fins have such a projection and very particularly preferably, at least half of the fins have such a projection. In the compressed state of the fins, the projections make the clamping sleeve grip the surface of the sensor, which reduces the risk even further of the sensor changing position within the clamping sleeve.

The clamping sleeve consists in particular of at least one plastic. As a result, it is possible to install the sensor in the clamping sleeve in a non-metallic environment, which is particularly advantageous when the sensor is an inductive sensor. The modulus of elasticity of the plastic is preferably 5 GPa maximum, particularly preferably 3 GPa maximum, in order to enable simple reversible bending of the fins. The modulus of elasticity can be determined in particular in the tensile test in accordance with the standard DIN EN ISO 527.

The plastic can contain fillers. It preferably contains exclusively electrically non-conductive fillers, such as glass fibres, and no electrically conductive fillers such as metal fibres or carbon fibres. This likewise ensures that the sensor is not introduced into an electrically conductive environment.

As well as the clamping nut, further nuts can be attached to the clamping sleeve on the external thread of the clamping sleeve. For example, the clamping sleeve can be fixed in place in a hole in a housing, by inserting it in the hole and screwing one fastening nut onto the external thread of the second section from each side of the housing wall.

In particular, a further section in which the clamping sleeve is neither slotted nor has an external thread can be arranged between the first section and the second section.

The length of the second section of the clamping nut is preferably shorter than the length of the fins. As a result, the fins protrude from the clamping nut and therefore contact the sensor with a large contact area.

The internal angle is understood as that angle which, in the cross-section of the clamping nut, is spanned between one of its angled inner lateral surfaces and the longitudinal axis of the clamping nut. In order to press the fins closely against the sensor and therefore create a sufficiently large area of contact with the sensor, it is preferred that the internal angle is 45° maximum. Particularly preferably it is 30° maximum and very particularly preferably it is 15° maximum.

Furthermore, it is preferred that the internal angle is smaller than the arctangent of the coefficient of static friction between the material of the clamping sleeve and the material of the clamping nut. This has the effect that the clamping sleeve and the clamping nut are self-locking when the clamping nut is in the tightened state, so that the clamping mount is resistant to loosening caused by vibrations.

The clamping nut preferably consists of at least one plastic. As a result, the clamping nut does not create an electrically conductive environment around the sensor. With regard to any fillers in the plastic of the clamping nut, the same applies as was stated for fillers in the plastic of the clamping sleeve. With regard to the modulus of elasticity, no particular requirements are placed on the plastic of the clamping nut, however.

For ease of manufacture of the clamping mount, it is preferable if the clamping sleeve and the clamping nut consist of the same plastic. Furthermore, this plastic is preferably a thermoplastic material, meaning that the clamping sleeve and the clamping nut can be easily produced in an injection moulding process.

### BRIEF DESCRIPTION OF THE DRAWINGS

Exemplary embodiments of the invention are shown in the drawings and are explained in more detail in the description that follows.

FIG. 1 shows an isometric illustration of a clamping sleeve of a clamping mount according to an exemplary embodiment of the invention.

FIG. 2 shows a front view of the clamping sleeve according to FIG. 1.

FIG. 3 shows a cross-sectional view of a clamping nut of a clamping mount according to an exemplary embodiment of the invention.

FIG. 4 shows, in a cross-sectional view, how in an exemplary embodiment of the invention a clamping nut is screwed onto a clamping sleeve.

FIG. 5 shows, in an isometric illustration, the insertion of a sensor into a clamping sleeve according to an exemplary embodiment of the invention.

FIG. 6 shows the assembly of a clamping mount according to an exemplary embodiment of the invention in an isometric illustration.

FIG. 7 shows, in a cross-sectional illustration, the deformation of a fin of a clamping sleeve in a clamping mount according to an exemplary embodiment of the invention.

### EXEMPLARY EMBODIMENTS OF THE INVENTION

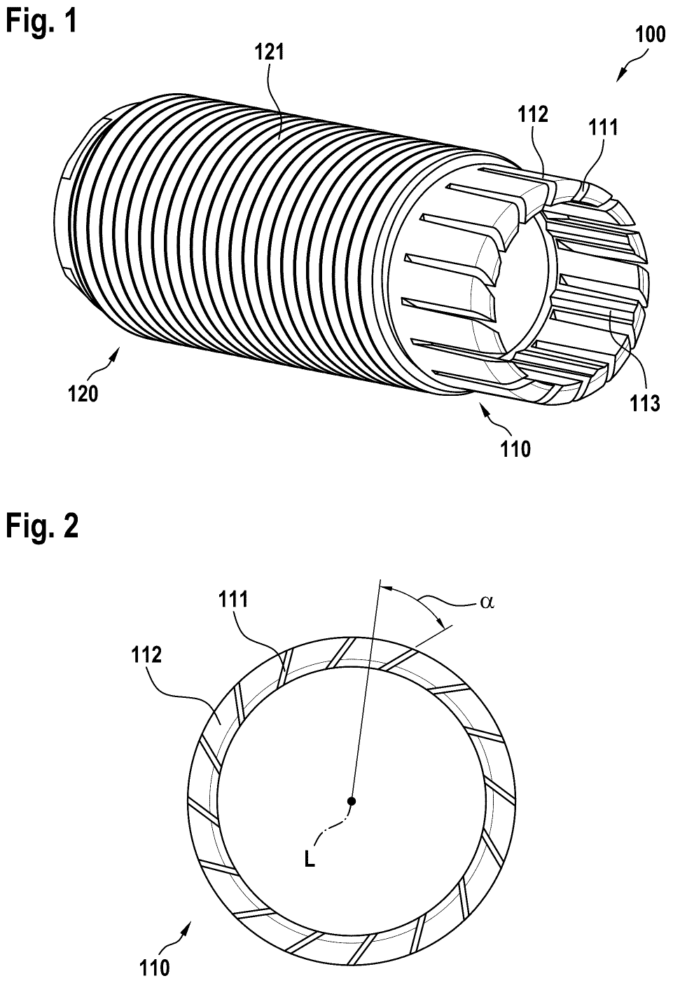

FIGS. 1 and 2 show a clamping sleeve 100 of a clamping mount according to an exemplary embodiment of the invention. The clamping sleeve 100 has the shape of a hollow circular cylinder and is divided into a first section 110 and a second section 120. In the first section 110, the clamping sleeve 100 has sixteen slots 111, by means of which the first section 110 is divided into sixteen fins 112. The length of each of the fins 112 is 9 mm, for example. Between these two sections 110, 120 there is arranged a further, for example 1 mm longer section, in which the clamping sleeve 100 is neither slotted nor has an external thread.

Each slot has an angle, which is 22.5° for example, with respect to a line parallel to the longitudinal axis L of the clamping sleeve 100. Each second fin has a respective projection 113 with triangular cross-section, which projects into the interior space of the clamping sleeve 100. In the second section 120, which adjoins the first section 110, the clamping sleeve 100 has an external thread 121.

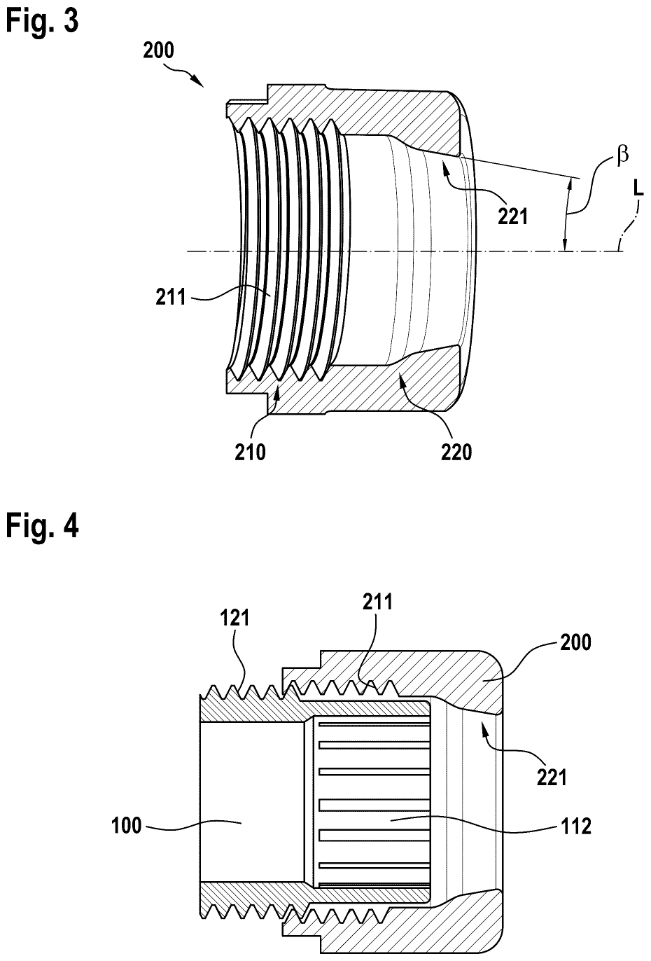

A clamping mount, according to one exemplary embodiment of the invention, has the clamping sleeve 100 and a clamping nut 200. This is shown in FIG. 3. The clamping sleeve 100 and the clamping nut 200 are each manufactured from polybutylene terephthalate (PBT), for example, which is filled to 30 vol % with glass fibres. The clamping nut 200 has a first section 210 and a second section 220. In the first section 210, the inner lateral surface of the clamping nut 200 extends parallel to the longitudinal axis L of the clamping nut, which is identical to the longitudinal axis of the clamping sleeve and the longitudinal axis of the clamping mount as a whole. An internal thread 211 is formed in this inner lateral surface of the first section 210. At the end of the first section 210, the inner lateral surface initially continues to extend parallel to the longitudinal axis L until it merges into a second section 220 of the clamping nut 200 in an angled region 221. The clamping nut 200 has a length of 17 mm, for example, and the second section 220 has a length of 5.5 mm, for example. The second section is therefore shorter than the fins 112. The angle β between the longitudinal axis L and the angled inner lateral surface 221 is 9.5°, for example. This value is less than the arctangent of the coefficient of static friction of 0.8 between the material of the clamping sleeve and the material of the clamping nut, which is 38.7°.

FIG. 4 shows how the first section 210 of the clamping nut 200 can be placed onto the first section 110 of the clamping sleeve 100. If the clamping nut 200 is now screwed onto the clamping sleeve 100 so that its internal thread 211 engages with the external thread 121 of the clamping sleeve 100, the fins 112 reach into the second section 220 of the clamping nut 200 and are twisted there and bent towards the longitudinal axis L. In the process, the non-slotted section of the clamping sleeve 100, which has no external thread 121, comes to lie between the two sections 210, 220 of the clamping nut 200.

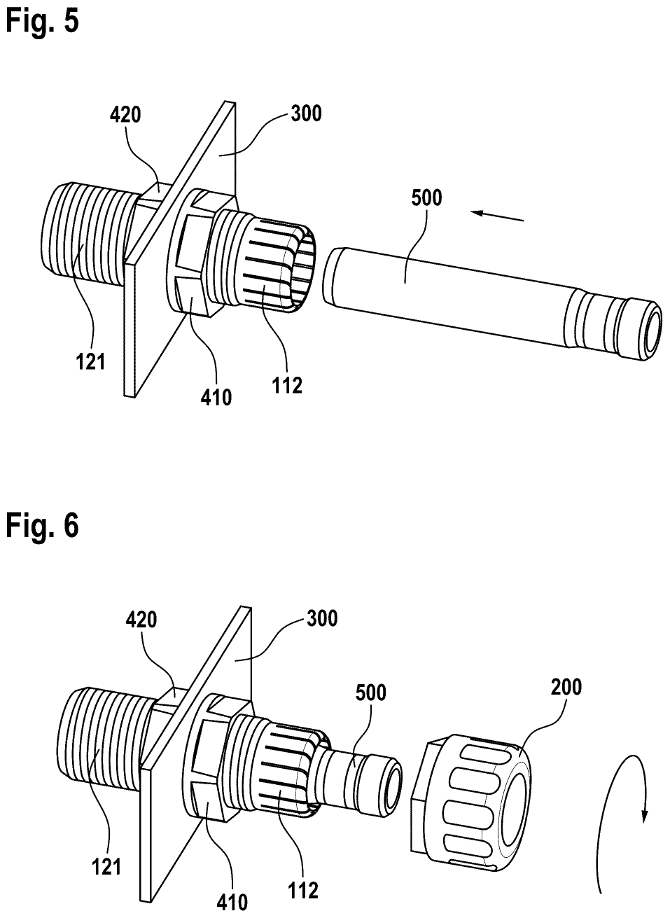

FIG. 5 shows how the clamping sleeve 100 can be fixed in place in an opening in a housing wall 300. For this purpose, a first fastening nut 410 is screwed from the first section 110 onto the external thread 121 of the clamping sleeve 100 until it bears against the housing wall 300. A second fastening nut 420 is screwed from the second section 120 over the external thread 121 until it too bears against the housing wall 300. A circular-cylindrical sensor 500 can now be pushed in the direction of the arrow into the clamping sleeve 100. Next, as shown in FIG. 6, the clamping nut 200 is first pushed over the sensor 500 and then over the first section 110 of the clamping sleeve 100 and screwed onto the external thread 121 of the clamping sleeve 100. In doing so, the fins 112 are pressed against the sensor 500 and fix the latter in place.

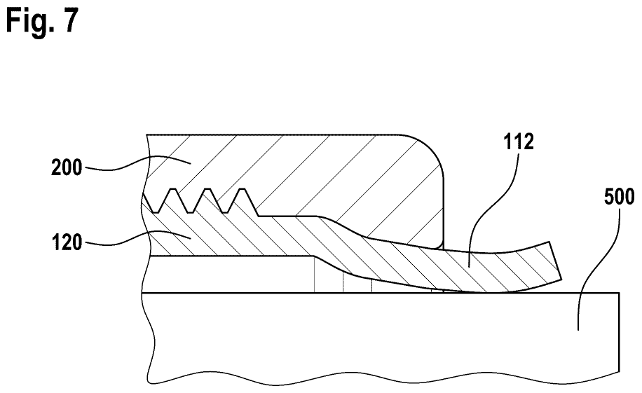

This is shown in FIG. 7 for a fin 112. In the second section 220 of the clamping nut 200, this fin extends initially along the angled lateral surface 221 and is thus pressed against the outer wall of the sensor 500. Outside of the clamping nut 200, the tip of the fin 112 bends away from the sensor 500 again. Nevertheless, an area of contact between the side wall of the fin 112 and the sensor 500 is created that is so high that the sensor 500 is prevented from slipping. At every second fin 112, the triangular projection 113 of the respective fin bears against the sensor 500, thereby fixing the latter even more securely in place.

1. A clamping mount for a sensor (500), comprising:
a clamping sleeve (100) with a first section (110), in which the clamping sleeve is divided by slots (111) into fins (112) extending parallel to its longitudinal axis (L), and a second section (120) with an external thread (121); and
a clamping nut (200) with a first section (210) in which the clamping nut has an internal thread (211) with which it is screwed onto the external thread (121) of the clamping sleeve (100) in such a way that the fins (112) are bent into an interior space of the clamping sleeve (100), wherein the clamping nut (200) has a second section (220) in which the inner lateral surface of the clamping nut is angled inwards by an internal angle (α) of at least 5°.

2. The clamping mount according to claim 1, wherein a length of the first section (110) of the clamping sleeve (100) is in the range from 5 mm to 15 mm.

3. The clamping mount according to claim 1, wherein the slots (111) in the clamping sleeve (100) each have an angle (α) which is in the range from 10° to 50° with respect to a line parallel to the longitudinal axis.

4. The clamping mount according to claim 1, wherein at least 3 fins (112) each have a projection (113) which projects into an interior space of the clamping sleeve (100) and has a triangular cross-section.

5. The clamping mount according to claim 1, wherein the clamping sleeve (100) consists of at least one plastic.

6. The clamping mount according to claim 1, wherein the internal angle (α) is 45° maximum.

7. The clamping mount according to claim 1, wherein the internal angle (α) is smaller than the arctangent of the coefficient of static friction between the material of the clamping sleeve (100) and the material of the clamping nut (200).

8. The clamping mount according to claim 1, wherein the clamping nut (200) consists of at least one plastic.
